(19) United States
(12) Patent Application Publication
(10) Pub. No.: US 2019/0272816 A1
(43) Pub. Date: Sep. 5, 2019

(54) HYBRID TRANSDUCER APPARATUS AND METHODS OF MANUFACTURE AND USE

(71) Applicant: Rowe Technologies, Inc., Poway, CA (US)

(72) Inventor: Sairajan Sarangapani, Poway, CA (US)

(21) Appl. No.: 16/292,069

(22) Filed: Mar. 4, 2019

Related U.S. Application Data
(60) Provisional application No. 62/637,794, filed on Mar. 2, 2018.

(51) Int. Cl. G10K 15/04; G01S 7/524

(52) U.S. Cl. CPC G10K 15/04; G10K 2200/11; G01S 7/524

(57) ABSTRACT

Hybrid transducer apparatus which is capable of simultaneously or sequentially forming multiple acoustic beams. In one implementation, the hybrid transducer apparatus consists of a relatively thin piezoceramic disk portion having an aspect ratio less than unity as well as a plurality of diced piezoelectric elements with each of these elements having an aspect ratio greater than unity. The resultant hybrid transducer apparatus reduces the multiple spurious frequency responses seen in prior art implementations and thus can be efficiently treated as a piezoelement having a single degree of freedom along its thickness direction. The hybrid transducer apparatus may also be suitable for use in high voltage and/or high power applications via the inclusion of, for example, a heat conductive epoxy that encapsulates the diced piezoelectric elements.

### PRIORITY

This application claims the benefit of priority to U.S. Provisional Patent Application Ser. No. 62/637,794 filed Mar. 2, 2018 of the same title, the contents of which being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNOLOGICAL FIELD

The present disclosure relates generally to a sonar transducer and in one exemplary aspect to a hybrid piezoelectric disk transducer for measuring current profiles in, for example, an Acoustic Doppler Current Profiler (ADCP) system.

### 2. DESCRIPTION OF RELATED TECHNOLOGY

Piezoelectric cylinders that are polarized through there thickness (e.g., by having electrodes on their end-surfaces) vibrate along their axial direction and are used for broadband underwater acoustic transducer applications such as, for example, in an in depth sounder, fish finder, and Acoustic Doppler Current Profilers. It is well known and established to those skilled in the art that the first fundamental mode along the thickness of the disk determines the transducer resonant frequency and the disk diameter determines the radiation surface. It is also well known and been shown that the resonant frequencies and effective coupling coefficients of finite sized piezoelectric cylinders are functions of their height-to-diameter ratios. For situations, where the aspect ratio is less than unity the cylinder is termed a “disk”, and when this aspect ratio is greater than unity it is known as a “rod” or “bar”. The vibration of these disks and rods may have a single degree of freedom in the axial direction under simple boundary conditions. When the aspect ratio is greater than 0.5 and less than 1.5 (e.g., 0.5<aspect ratio <1.5) the vibration of the transducer may no longer be considered a single degree of freedom system, as the vibration of the transducer is coupled in both its axial and radial directions.

Many broadband electroacoustic transducers have been designed, manufactured and used for Acoustic Doppler Current Profilers application where the aspect ratio is well beyond unity (e.g., >>1). For example, Canadian Publication No. CA2092564 describes the use of a disk transducer in a stack with different front and back layers with an aspect ratio greater than unity. Such an approach employing disk transducers is common today whereby a sound is radiated in a direction normal to the face of the piezoelectric acoustic transducer to achieve a directed beam. Another example may be found in U.S. Pat. No. 4,916,675 which describes a broadband acoustic transducer that uses different piezoelectric elements in order to form an omni-directional beam pattern at different resonance frequencies. Yet another example may be found in U.S. Pat. No. 8,223,588 which describes the use of a three disk transducer element and system that is configured to measure underwater currents. The transducer aspect ratio for this three disk transducer element is greater than unity.

Generally speaking, the height-to-diameter/width ratio (aspect ratio) of these prior transducer elements results in multiple coupled vibrations which results in a reduction of electromechanical coupling and inefficient projection of an acoustic wave in a desired direction. Accordingly, despite the variety of the foregoing techniques, these prior art transducers are limited in that: (1) the bandwidth is limited as a result of these multiple coupled vibrations; (2) their placement is limited in applications in which size is a design constraint; and (3) they are often times not suitable in high voltage and/or high power applications. Accordingly, transducer apparatus are desired that address the foregoing concerns.

### SUMMARY

The present disclosure addresses the foregoing needs by providing improved transducer apparatus and methods of manufacture and use.

In one aspect of the disclosure, a hybrid disk transducer is disclosed. In one embodiment, an electroacoustic transducer is disclosed which includes: a hybrid piezoelectric disk, the hybrid piezoelectric disk including: a thin disk portion; and a plurality of diced element portions, the thin disk portion and the plurality of diced element portions being formed from a unitary piezoceramic material; a syntactic foam material; and a high impedance material.

In one variant, the electroacoustic transducer further includes a heat conductive epoxy, the heat conductive epoxy surrounding the plurality of diced element portions of the hybrid piezoelectric disk.

In another variant, the electroacoustic transducer further includes a first set of electrodes and a second set of electrodes, the first set of electrodes being disposed on an external surface of the thin disk portion and the second set of electrodes being disposed on an end of the plurality of diced element portions.

In yet another variant, the electroacoustic transducer further includes a fiber glass-copper based conductive material, the fiber glass-copper based conductive material being disposed atop the first set of electrodes.

In yet another variant, the first set of electrodes and the second set of electrodes are configured to be excited partially.

In yet another variant, the thin disk portion includes an aspect ratio less than unity and a diced element portion of the plurality of diced element portions includes an aspect ratio greater than unity.

In another aspect of the disclosure, a hybrid piezoelectric disk is disclosed. In one embodiment the hybrid piezoelectric disk includes: a thin disk portion; and a plurality of diced element portions, the thin disk portion and the plurality of diced element portions being formed from a unitary piezoceramic material

In yet another aspect of the disclosure, a transducer assembly for use in an Acoustic Doppler Current Profiler (ADCP) application is disclosed.

In yet another aspect of the disclosure, methods of manufacturing or using any of the aforementioned transducer assemblies are disclosed.

These and other aspects of the disclosure shall become apparent when considered in light of the disclosure provided herein.

### BRIEF DESCRIPTION OF THE DRAWINGS

The features, objectives, and advantages of the disclosure will become more apparent from the detailed description set forth below when taken in conjunction with the drawings, wherein:

FIG. 1 is a perspective view of a hybrid piezoelectric disk, in accordance with the principles of the present disclosure.

FIG. 1A is a cross-sectional view of the hybrid piezoelectric disk of FIG. 1, in accordance with the principles of the present disclosure.

FIG. 1B is a cross-sectional view of the hybrid piezoelectric disk of FIG. 1 in which a heat conductive epoxy is disposed between the pillars, in accordance with the principles of the present disclosure.

FIG. 1C is a cross-section view of the hybrid piezoelectric disk of FIG. 1 illustrating the positioning of electrodes, in accordance with the principles of the present disclosure.

FIG. 2 is a perspective view of single beam being generated by a transducer apparatus that utilizes the hybrid piezoelectric disk of FIG. 1, in accordance with the principles of the present disclosure.

FIG. 3 is a perspective view of the transducer apparatus of FIG. 2 in which multiple beams are formed from the hybrid piezoelectric disk of FIG. 1, in accordance with the principles of the present disclosure.

All Figures disclosed herein are © Copyright 2018 Rowe Technologies, Inc. All rights reserved.

### DETAILED DESCRIPTION OF THE PREFERRED EMBODIMENT

Reference is now made to the drawings wherein like numerals refer to like parts throughout.

### Overview

The present disclosure provides, inter alia, a hybrid transducer apparatus which is capable of simultaneously or sequentially forming multiple acoustic beams along a given axis. The hybrid transducer apparatus consists of a relatively thin disk portion having an aspect ratio less than unity as well as a plurality of diced piezoelectric elements with each of these elements having an aspect ratio greater than unity. The resultant hybrid transducer apparatus reduces the multiple spurious frequency responses seen in prior art implementations and thus can be efficiently treated as a piezoelement having a single degree of freedom along the thickness direction. The hybrid transducer apparatus may also be suitable for use in high voltage and/or high power applications via the inclusion of, for example, a heat conductive epoxy that encapsulates the diced piezoelectric elements.

### DETAILED DESCRIPTION OF EXEMPLARY EMBODIMENTS

Detailed descriptions of the various embodiments and variants of the apparatus and methods of the disclosure are now provided. While primarily discussed in the context of Acoustic Doppler Current Profiler (ADCP) applications, the various apparatus and methodologies discussed herein are not so limited. In fact, many of the apparatus and methodologies described herein are useful in other known sonar applications. For example, the transducer apparatus disclosed herein may be utilized in determining zooplankton size and distribution, fish finders, Doppler velocity logs used for navigation and other suitable types of sonar applications.

### Hybrid Design Transducers—

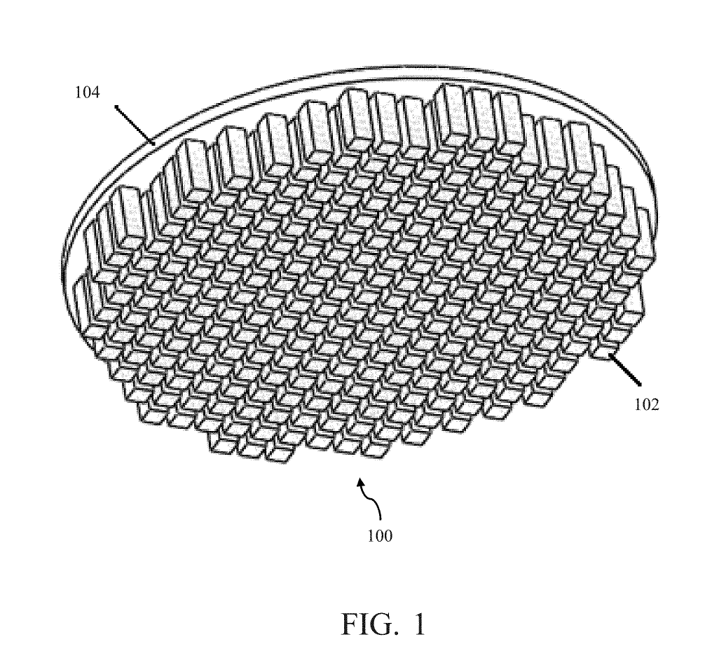

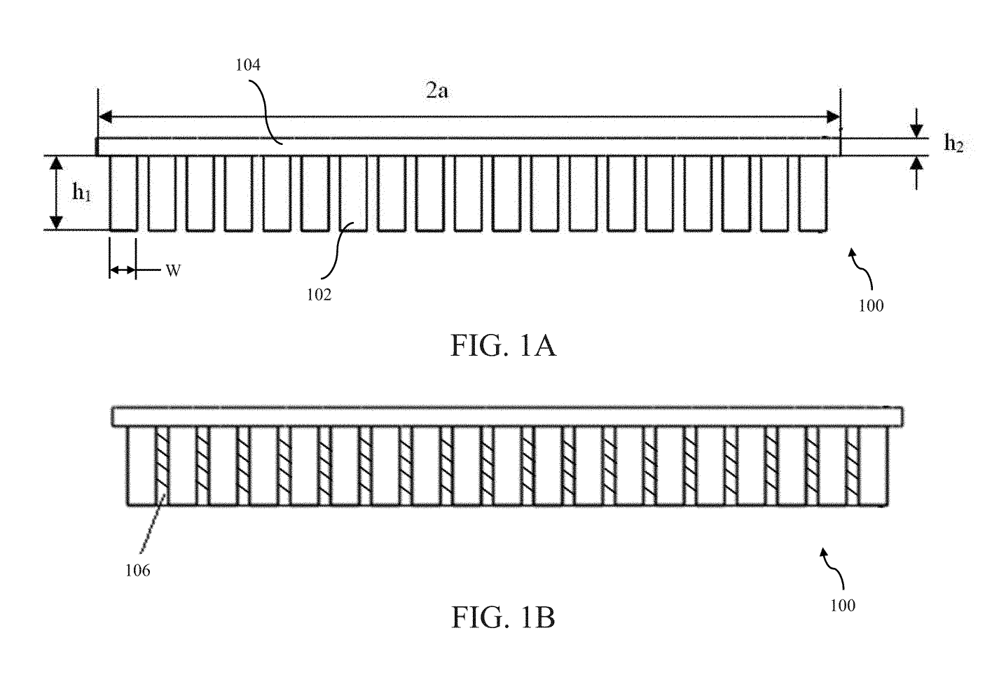

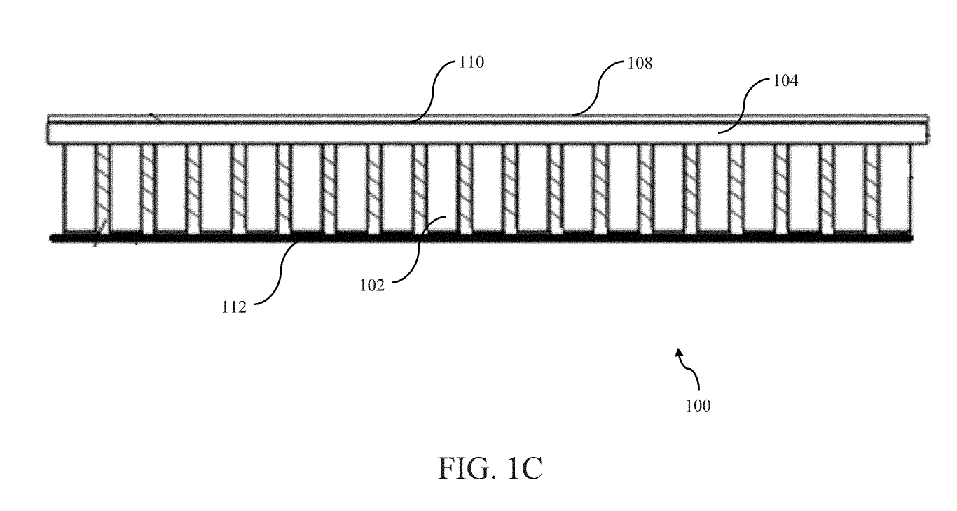

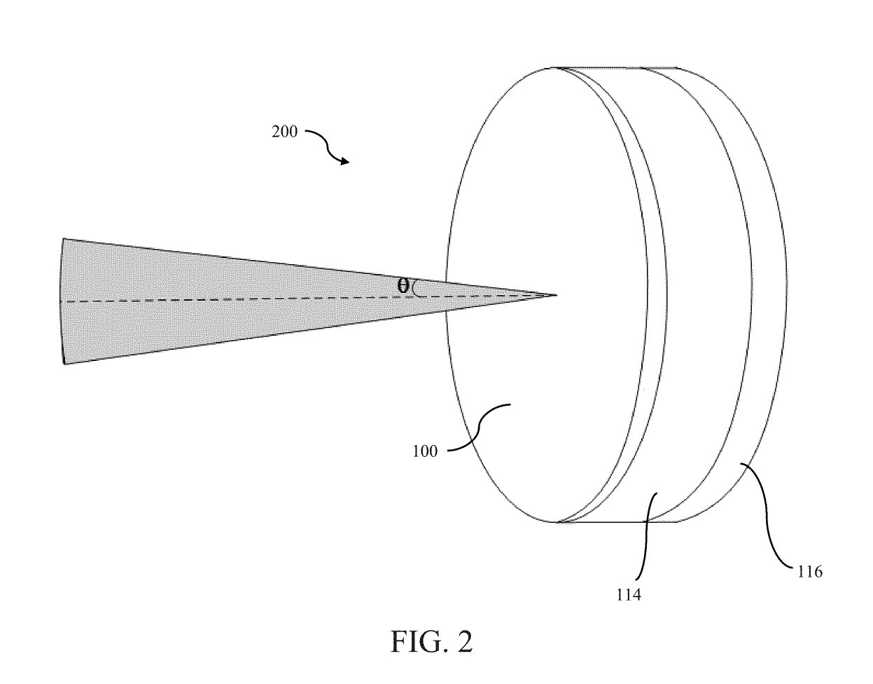

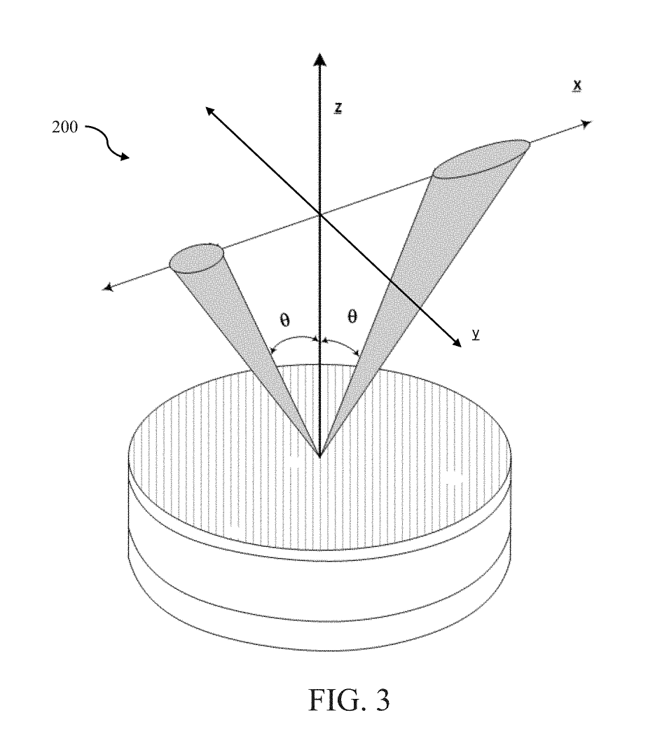

The present disclosure relates to electroacoustic transducers and more specifically with the use of piezoelectric disk transducers with aspect ratios greater than, for example, 0.5 and less than, for example, 1.5 for, inter alia, ADCP applications. Referring now to FIGS. 1-1C, a piezoelectric disk 100 is shown that is partially diced through its height (thickness). The diced portion 102 of the disk 100 includes a number of rectangular elements each having an aspect ratio in which h₁/w is greater than unity, while the remaining thin disk portion 104 of the disk has an aspect ratio in which h₁+h₂/2α is less than unity. Collectively, these portions make up a so-called “hybrid” piezoelectric disk for use with, for example, the transducer apparatus 200 shown in FIGS. 2 and 3. The illustrated hybrid piezoelectric disk 100 effectively reduces the multiple spurious frequency responses as has been seen in prior art implementations and can be efficiently treated as a piezoelement having a single degree of freedom along the thickness direction.

FIG. 1A illustrates the dimensional relationship of the piezoelectric disk 100 discussed above. The disk electrodes (described subsequently herein with respect to FIG. 1C) are applied to the end-surfaces of the disk 100 and the piezoelectric disk 100 is polarized along the axial (height) direction. This hybrid diced design employs dicing along the thickness direction resulting in a thin disk portion 104 having a height-to-diameter aspect ratio of less than one and a plurality of rectangular elements 102 each having a height-to-width aspect ratio greater than one. In some implementations, the height-to-diameter ratio is less than one for the think disk portion 104 and the height-to-width ratio for each of the diced elements 102 is greater than one. The illustrated diced portion 102 of the disk 100 includes a plurality of rectangular elements which is resultant from a dicing operation that occurs along two separate orthogonal directions. While, rectangular elements are shown, it would be readily apparent that this shape may be modified in some implementations. For example, other polygonal shapes (e.g., hexagonal, octagonal, etc.) may be realized for this diced portion 102 if the number of dicing directions is increased over the aforementioned two orthogonal directions.

According to some implementations of the present disclosure, the dicing depth can be varied so as to provide for an optimum electromechanical coupling coefficient thereby improving the electromechanical conversion of the transducer. Additionally, the hybrid diced design shown in FIGS. 1-1C can effectively increase the bandwidth of the transducer by 25% of the operating frequency as compared with a diced phased array transducer such as that described in co-owned U.S. patent application Ser. No. 13/282,257 filed Oct. 26, 2011 entitled “Multi Frequency 2D Phased Array Transducer”, the contents of which being incorporated herein by reference in its entirety. The piezoelectric disk transducer 100 may use a fiber glass-copper based conductive material (108, FIG. 1C) in front of the piezoelectric transducer and use a thin foam based backing material (114, FIG. 2) that may be dimensioned on the order of about 20% of the aspect ratio of the piezoceramic disk 100 in order to help achieve this wide bandwidth (e.g., 25% of the frequency of resonance). For example, if the thin foam based backing material (114, FIG. 2) possesses the same diameter as the piezoelectric disk transducer 100, then in some implementations, the thin foam thickness may be dimensioned so as to have about 20% of the height of the piezoceramic disk.

FIG. 1B illustrates a variant of the piezoelectric disk transducer 100 which may be suitable for high voltage and/or high power applications. Specifically, the disk 100 includes a heat (thermal) conductive epoxy 106 disposed around the diced portion 102 of the disk 100. This heat conductive epoxy 106 may be used to encapsulate the diced portion 102 of the piezoelectric disk 100 in order to facilitate heat dissipation as well as to provide additional strength to the diced portion 102 of the disk 100. In other words, the heat generated with high voltage and/or high power applications may be dissipated more effectively when utilized in conjunction with this heat conductive epoxy 106 as the heat conductive epoxy facilitates the removal of heat from the transducer disk 100. The heat conductive epoxy 106 may also allow for the transmission of sound through this heat conductive epoxy. FIG. 1C illustrates an exemplary placement of the electrodes 110, 112 for this piezoelectric disk 100. A first set of electrodes 110 may be placed on one side of the thin disk portion 104 and a second set of electrodes 112 may be placed on one end of the diced portion 102 of the disk 100. These electrodes 110, 112 may be configured such that a subset of these electrodes may be excited in addition to a full excitation of these electrodes. A fiber glass-copper based conductive material 108 may additionally be placed over the first set of electrodes 110.

Referring now to FIG. 2, an exemplary transducer apparatus 200 that utilizes the piezoelectric disk transducer 100 of FIGS. 1-1C is shown and described in detail. The transducer apparatus 200 may be coupled with electronic circuitry in order to realize operation as an acoustic source and/or as an acoustic receiver that is capable of measuring, inter alia, the speed of water currents, depths of a given water column, as well as for the detection of underwater objects. In other words, the transducer apparatus 200 disclosed herein may transmit acoustic waves and measure the volume or surface backscattering signal strength in order to determine, for example, the depth of a given water column. The transducer apparatus 200 shown in FIG. 2 may consist of a plurality of layers resulting in a so-called half-passive stack. For example, the first layer 100 may consist of the aforementioned hybrid piezoelectric ceramic disk illustrated in FIGS. 1-1C; while layer 114 may consist of a syntactic foam; and layer 116 may consist of a high impedance material (e.g., steel). The syntactic foam layer 114 may consist of a glass sphere syntactic foam made by using a high-performance epoxy resin as the polymeric binder. The high impedance material layer 116 provides, inter alia, a perfect boundary condition for the radiation of beams underwater. The piezoelectric ceramic layer 100 may be the only active material in the stack. Due to cost (as well as thickness) considerations, these layers can be bonded together resulting in a cost effective and durable transducer design. As but another example, layers 114, 116 may consist of a baffle material such as a so-called Syntactic Acoustic Damping Material (SADM). The use of SADM (and other suitable baffle materials) may operate to act as an acoustic baffle which causes the transducer 200 to radiate energy to the front of the transducer surface, while minimizing/eliminating radiation in other directions. In addition, the use of SADM isolates the transducer 200 from the structure to which it is installed. These baffle materials may be chosen such that they are lightweight, yet provide high acoustic isolation.

Referring now to FIG. 3, exemplary operation of the transducer apparatus 200 is shown and described in detail. Specifically, transducer apparatus 200 may act as a single-dimensional phased array. As illustrated, two beams are simultaneously formed along the x-axis and may be utilized in narrow band or broad band applications. Alternatively, two beams may be simultaneously formed along the y-axis and may also be utilized in narrow band or broad band applications. The two beams may also be generated at an angle θ relative to the z-axis. In some implementations, a beam may be formed normal to the transducer face. The use of the hybrid piezoelectric disk 100 may also be beneficial in designs in which the overall size is a constraint. In other words, the width (e.g., dimension 2a) of piezoelectric disk 100 may be constrained by an end application and the dimensions h₁, h₂, and w may all be varied in order to meet the constrained width dimension. As previously discussed above, the transducer 200 may also be excited partially or completely. Accordingly, the varying ways in which the transducer 200 may be excited is useful in order to produce different beamwidths. For example, a subset of the electrodes 110, 112 may be excited in one usage scenario resulting in a wider beam width, while another usage scenario may excite the full set of electrodes 110, 112 resulting in a narrower beam width. The transducer 200 may also be operated in a transmit mode of operation where the acoustic beams are being formed, or a receive mode of operation where backscattered beams are detected. These and other variants would be readily apparent to one of ordinary skill given the contents of the present disclosure.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the implementations disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. An electroacoustic transducer for producing sound in a fluid medium, comprising:
a hybrid piezoelectric disk, the hybrid piezoelectric disk comprising:
a thin disk portion; and
a plurality of diced element portions, the thin disk portion and the plurality of diced element portions being formed from a unitary piezoceramic material;
a syntactic foam material; and
a high impedance material.

2. The electroacoustic transducer of claim 1, further comprising a heat conductive epoxy, the heat conductive epoxy surrounding the plurality of diced element portions of the hybrid piezoelectric disk.

3. The electroacoustic transducer of claim 2, further comprising a first set of electrodes and a second set of electrodes, the first set of electrodes being disposed on an external surface of the thin disk portion and the second set of electrodes being disposed on an end of the plurality of diced element portions.

4. The electroacoustic transducer of claim 3, further comprising a fiber glass-copper based conductive material, the fiber glass-copper based conductive material being disposed atop the first set of electrodes.

5. The electroacoustic transducer of claim 4, wherein the first set of electrodes and the second set of electrodes are configured to be excited partially.

6. The electroacoustic transducer of claim 5, wherein the thin disk portion comprises an aspect ratio less than unity and a diced element portion of the plurality of diced element portions comprises an aspect ratio greater than unity.
